(19) United States
(12) Patent Application Publication
(10) Pub. No.: US 2025/0131264 A1
(43) Pub. Date: Apr. 24, 2025

(54) ON-CHIP TRAINING OF MACHINE LEARNING MODEL

(71) Applicant: Texas Instruments Incorporated, Dallas, TX (US)

(72) Inventors: Kaichien Tsai, ALLEN, TX (US); Yijie Wei, DALLAS, TX (US); Jiaxin Teng, CYPRESS, TX (US); Yanming Luo, SUGAR LAND, TX (US)

(73) Assignee: Texas Instruments Incorporated, Dallas, TX (US)

(21) Appl. No.: 18/820,765

(22) Filed: Aug. 30, 2024

Related U.S. Application Data
(60) Provisional application No. 63/591,141, filed on Oct. 18, 2023.

(51) Int. Cl. G06N 3/08; G06F 11/07; G06F 17/11

(52) U.S. Cl. CPC G06N 3/08; G06F 11/0736; G06F 11/079; G06F 17/11

(57) ABSTRACT

In one example, a method comprises providing first data to a machine learning model to generate second data. The method further comprises determining errors based on the second data and target second data; determining loss gradients based on the errors. The method further comprises updating running sums of prior loss gradients by adding the gradients to the running sums; and updating model parameters of the machine learning model based on the updated running sums.

### CROSS-REFERENCE TO RELATED APPLICATIONS

This application claims priority to: U.S. Provisional Patent Application No. 63/591,141, titled “On-chip Machine Learning”, filed Oct. 18, 2023, which is incorporated herein by reference in its entirety.

### BACKGROUND

A machine learning model can be trained to find patterns or make decisions from a set of input data. One example of machine learning model is an artificial neural network, which can have an architecture based on biological neural networks. Training a machine learning model may involve a large amount of memory and computation resources, which makes it challenging to train a machine learning model on devices with limited memory and computation resources.

### SUMMARY

In one example, a method comprises providing first data to a machine learning model to generate second data. The method further comprises determining errors based on the second data and target second data; determining loss gradients based on the errors. The method further comprises updating running sums of prior loss gradients by adding the gradients to the running sums; and updating model parameters of the machine learning model based on the updated running sums.

In one example, an integrated circuit comprises a sensor interface, a memory, and a processor. The memory is configured to store data and instructions. The processor is configured to receive first data via the sensor interface. The processor is also configured to receive, from the memory, at least a subset of the data representing a machine learning model, model parameters of the machine learning model, and running sums of prior loss gradients. The processor is also configured to generate second data by providing the first data to the machine learning model. The processor is also configured to determine errors based on the second data and target second data. The processor is configured to determine loss gradients based on the errors; update the running sums based on adding the loss gradients to the running sums; update the model parameters based on the updated running sums; and store the updated model parameters and the updated running sums in the memory.

### BRIEF DESCRIPTION OF THE DRAWINGS

FIG. 1 is a schematic diagram illustrating a system in which inferencing operations can be performed, according to some examples.

FIG. 2 is a flowchart illustrating an example sequence of operations to support the inferencing operation of FIG. 1.

FIG. 3 is a schematic of an example machine learning model to perform the inferencing operations of FIG. 1.

FIG. 4 is a schematic of examples of internal components of a processor of FIG. 1 to support an on-chip training operation.

FIG. 5 is a flowchart illustrating an example on-chip training operation.

FIG. 6 includes a graph that illustrates an example of errors with training rounds of an on-chip training operation.

FIG. 7 is a schematic of examples of internal components of a processor of FIG. 1 to support an on-chip training operation.

FIG. 8 is a schematic of examples of internal components of a processor of FIG. 1 to support an on-chip training operation.

FIG. 9 includes a graph that illustrates an example of errors with training rounds of an on-chip training operation based on running sums of prior loss gradients.

FIG. 10 includes a flowchart that illustrates an example of on-chip training operation of a neural network.

FIG. 11 includes a schematic of a processor platform that can perform examples of on-chip training operations and inferencing operations described herein.

The same reference numbers are used in the drawings to designate the same (or similar) features.

### DETAILED DESCRIPTION

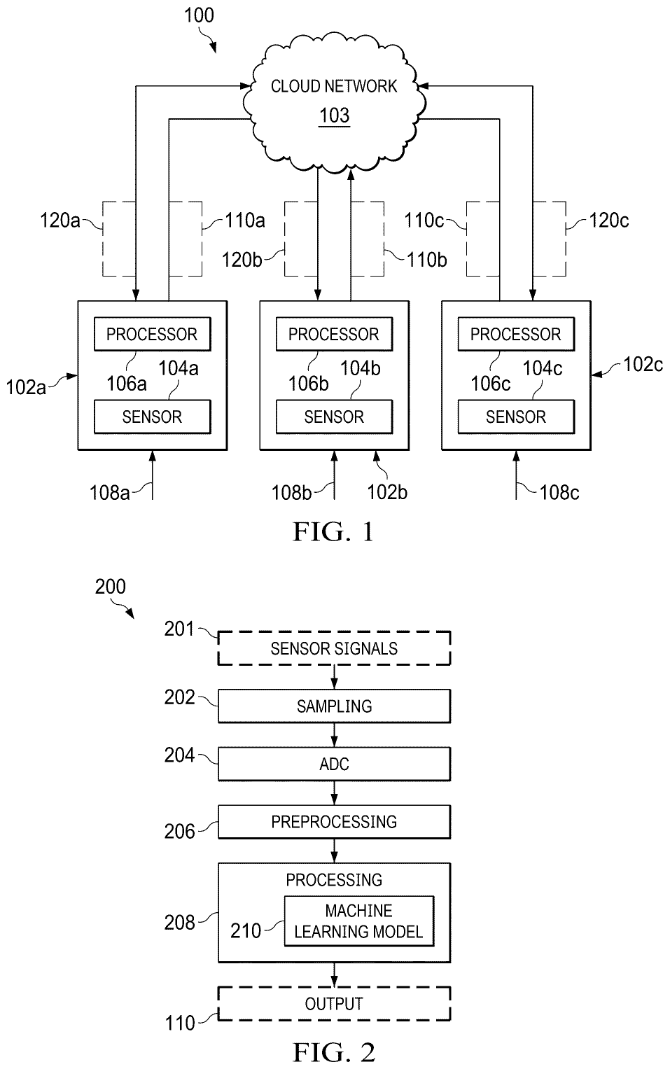

FIG. 1 is a schematic diagram illustrating a system 100. System 100 can include multiple electronic devices 102, including electronic devices 102a, 102b, and 102c, and a cloud network 103. Each electronic device 102 can include a sensor 104 and a processor 106. For example, electronic device 102a includes sensor 104a and data processor 106a, electronic device 102b includes sensor 104b and data processor 106b, and electronic device 102c includes sensor 104c and data processor 106c. In some examples, sensor 104 and processor 106 can be part of an integrated circuit (IC). In some examples, processor 106 and sensor 104 can be on different ICs, and processor 106 can have a sensor interface to couple to sensor 104.

Sensor 104 can be of various types, such as audio/acoustic sensors, motion sensor, image sensors, voltage and current sensors, etc. In some examples, each electronic device 102 can include multiple sensors of different types (e.g., acoustic sensor, motion sensor, voltage and current sensors), or multiple instances of the same type of sensors (e.g., multiple microphones). Each sensor system can receive a stimulus 108 (e.g., an acoustic signal, a light signal, an electrical signal, a motion, etc.) and generate an output 110 based on the received stimulus. The output can indicate, for example, whether an event of interest is detected. For example, electronic device 102a can generate an output 110a based on stimulus 108a, electronic device 102b can generate an output 110b based on stimulus 108b, and electronic device 102c can an output 110c based on stimulus 108c.

In some examples, each electronic device 102 can be part of an Internet-of-Things (IoT) end node, and can be part of edge devices of network 103. Each electronic device 102 can also be attached or collocated with other device. For example, each electronic device 102 can be attached to a motor to measure the voltage/current of the motor, and different electronic device 102 can be attached to different motors. Each electronic device 102 can transmit its respective output 110 to cloud network 103, which can perform additional operations based on the outputs (e.g., transmitting an alert about a fault event, remotely disabling a faulty device, etc.).

Processor 106 of a particular electronic device 102 can perform processing operations on the signals collected by sensor 104 (e.g., voltage/current measurements, audio data, image data, motion data, etc.) on the particular electronic device to generate output 110. For examples, in examples where sensor 104 includes voltage/current sensors, processor 106 can perform processing operations, such as fault detection on a sequence of voltage/current signals. Also, in examples where sensor 104 includes an audio/acoustic sensor, data processor 106 can perform processing operations such as keyword spotting, voice activity detection, and detection of a particular acoustic signature (e.g., glass break, gunshot). Also, in examples where sensor 104 includes a motion sensor, data processor 106 can perform processing operations such as vibration detection, activity recognition, and anomaly detection (e.g., whether a window/a door is hit or opened when no one is at home or in night time). Further, in examples where sensor 104 includes an image sensor data processor 106 can perform processing operations such as face recognition, gesture recognition, and visual wake word detection (e.g., determining whether a person is present in an environment).

Processor 106 can process the sensor signals generated by sensor 104 to generate output 110. FIG. 2 illustrates an example of a sequence of operations 200 of processor 106. Referring to FIG. 2, processor 106 can receive sensor signals 201 from sensor 104, and perform sampling operation 202 on to generate samples, and analog-to-digital conversion (ADC) operation 204 to convert the sampled signals to digital values. Processor 106 can perform pre-processing operation 206 to pre-process the digital values. In some examples, the pre-processing can be performed to, for example, extract or emphasize features of the sensor signal that can facilitate the subsequent processing operation. In some examples, the pre-processing operation can include a domain transformation operation, such as a transformation operation from time domain to frequency domain, to extract frequency components of the sensor signal. The frequency components of the sensor signal can provide a more distinctive signature to facilitate detection/non-detection of an event. In some examples, pre-processing operation 206 can include a Fourier transform operation, such as N-point fast Fourier transform (FFT) operation, on batches of N samples of sensor signal, to generate the frequency components of the sensor signal. For example, pre-processing operation 206 can include a 2048-point FFT to process a batch of 2048 samples at a time.

Following pre-processing operation 206, processor 106 can perform a processing operation 208 on the pre-processed sensor signals (e.g., FFT outputs) to provide output 110. The processing operation can include a detection operation (e.g., a fault detection, voice recognition, vibration detection, etc.) based on the sensed signals. In some examples, processor 106 may implement a machine learning model 210, such as an artificial neural network, that is trained to perform an inferencing operation and/or a classification operation on the pre-processed sensor signals to support the processing operation. As to be described below, the model parameters of machine learning model 210 can be updated in a training operation to improve the likelihood of processing operation 208 providing a correct output, such as a correct detection, rather than false detection, of an event (e.g., a fault event, a security breach event, etc.).

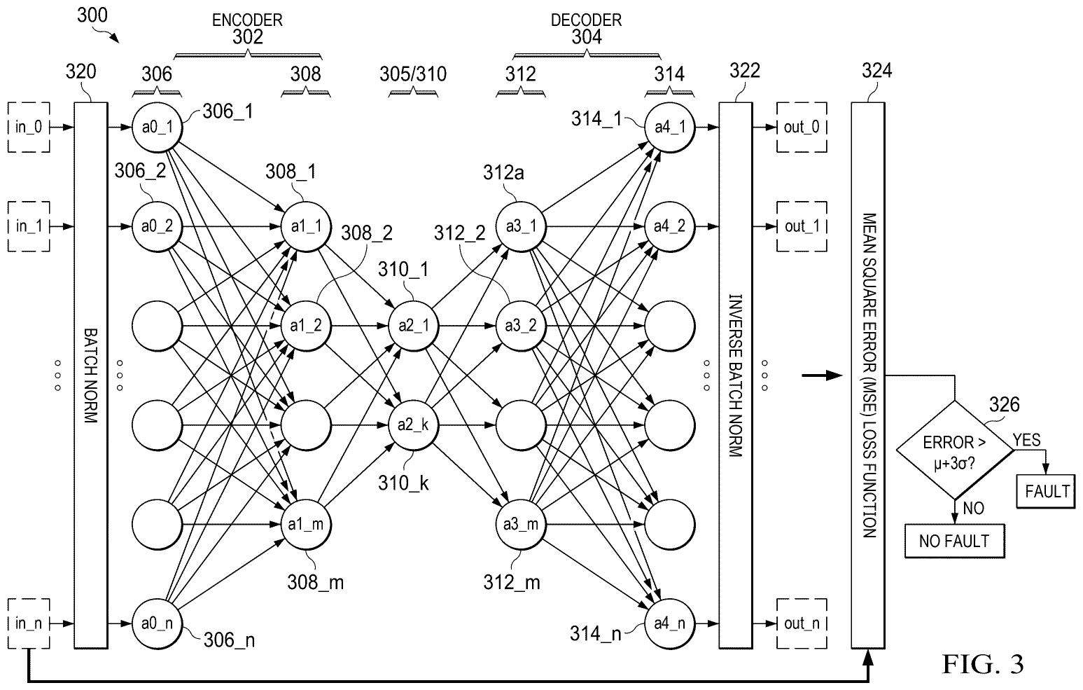

An artificial neural network (herein after “neural network”) may include multiple processing nodes. Examples of neural networks includes an autoencoder, a deep neural network (DNN), a convolutional neural network (CNN), etc. FIG. 3 illustrates an example of an autoencoder 300 that can be part of machine learning model 210. As shown in FIG. 3, autoencoder 300 can include an encoder section 302, a decoder section 304, and a bottleneck section 305 between encoder section 302 and decoder section 304. Each of encoder section 302, decoder section 304, and bottleneck section 305 includes one or more neural network layers. For example, encoder section 302 includes neural network layers 306 and 308, bottleneck section 305 includes a neural network layer 310, and decoder section 304 includes neural network layers 312 and 314. As to be described below, encoder section 302 and decoder section 304 are mirror of each other, with decoder section 304 configured to provide outputs that match with the inputs to encoder section 302.

Each neural network layer includes one or more processing nodes each configured to operate like a neuron. For example, neural network layer 306 includes processing nodes 306_0, 306_2, . . . 306_n, neural network layer 308 includes a processing node 308_1, 308_2, . . . 308_m, neural network layer 310 includes a processing node 310_1 and 310_2, neural network layer 312 includes processing nodes 312_1, 312_2, . . . 312_m, and neural network layer 316 includes processing nodes 316_1, 316_2, . . . 316_n.

In the example of FIG. 3, neural network layer 306 can be an input layer, neural network layer 314 can be an output layer, and neural network layers 308 and 312 can be intermediate layers. Neural network layer 306 can receive and process a batch of input data elements a0 (e.g., a0_0, a0_1, . . . a0_n) at a time, where each processing node of neural network layer 306 can receive an input data element of the batch. For example, if pre-processing operation 206 performs a 2048-point FFT and generates frequency components in 120 frequency bins at a time (represented as in_1, in_2, . . . in_n in FIG. 3), each frequency bin can provide an input data element, and neural network layer 306 can include 120 processing nodes (where n=120), and each of the 120 processing nodes can process a corresponding one of the 120 frequency bins. In some examples, processing operation 208 may include a batch normalization operation 320 on data elements in_1, in_2, . . . in_n, which includes re-centering and re-scaling of the data elements, to generate input data elements a0_1, a0_2, . . . a0_n. Batch normalization operation 320 can improve the speed and stability of training operation of autoencoder 300.

Each processing node of neural network layer 306 can receive a corresponding input data element of the batch (e.g., node 306_1 receives a0_1, node 306_2 receives a0_2, node 306_n receives a0_n), and generate a set of intermediate output data elements, one for each of nodes 308_1, 308_2, 308_n, etc., by scaling the input data element with a set of weights element w1.

Neural network layer 308 includes m number of processing nodes, with m smaller than n. Each of the m number of processing nodes of the neural network layer 308 can receive the scaled input data elements from each of the n number of processing nodes of neural network layer 306, and generate intermediate output data elements a1 (e.g., a1_1, a1_2, a1_m) by summing the scaled input data elements and adding a bias term b1 to the sum. For example, processing node 308_1 can generate intermediate output data element a1_1 as follows:

$$a1\_ 1 = {\sum }_{i = 1}^{i = n} ( w1\_i \times a0\_i ) + b1\_ 1 \qquad ( Equation 1 )$$

In Equation 1, w1_i represents one of the set of weight elements w1 used by a processing node of neural network layer 306 to scale a corresponding input data element a0. For example, processing node 306_1 scales input data element a0_1 with a weight element w1_1, processing node 306_2 scales input data element a0_2 with a weight element w1_2, processing node 306_n scales input data element a0_n with a weight element w1_n. Also, b1_1 represents the bias term added to the sum of scaled input data elements. A different processing node of neural network layer 308, such as processing node 308_2, 308_m, etc., can receive input data elements scaled with a different set of weights w1, and add a different bias term b1 to the sum.

Neural network layer 310 of bottleneck section 305 includes k number of processing nodes, with k smaller than m. Each processing node of neural network layer 310 can receive an intermediate data element from each of the m number of processing node of neural network layer 308 (e.g., a1_1 from processing node 308_1, a1_2 from processing node 308_2, a1_m from processing node 308_m, etc.), scales the intermediate data elements with a set of weight elements w2, sum the scaled intermediate data elements, and add a bias term b2 to the sum. Each of neural network layer 310 can also process the sum with an activation function, such as a Rectified Linear Unit function (ReLU), to generate an intermediate data element a2. The activation function can introduce non-linearity and mimic the operation of a neuron. For example, processing node 310_1 can generate intermediate output data element a2_1 as follows:

$$a2\_ 1 = ReLU ( {\sum }_{i = 1}^{i = m} ( w2\_i \times a1\_i ) + b2\_ 1 ) \qquad ( Equation 2 )$$

In Equation 2, w2_i represents one of the sets of weight elements w2 used by a processing node of neural network layer 310 to scale an intermediate input data element a1_i output by one of the processing nodes of neural network layer 308. For example, processing node 310_1 scales intermediate data element a1_1 from processing node 308_1 with a weight element w2_1, scales input data element a1_2 from processing node 308_2 with a weight element w2_2, and scales immediate data element a1_m from processing node 308_m with a weight element w2_m. Also, b2_1 represents the bias term added to the sum of scaled intermediate data elements. A different processing node of neural network layer 310, such as processing node 310_m, etc., can scale the intermediate data elements a1 with a different set of weights w2 to generate the sum, and add a different bias term b2 to the sum.

Neural network layer 312 includes m number of processing nodes and mirrors neural network layer 308. Each of the m number of processing nodes of the neural network layer 312 can receive an intermediate data element a2 from each processing node of neural network layer 310 (e.g., a2_1 from processing node 310_1, a2_k from processing node 310_k), scale the intermediate elements with a set of weights w3, sum the scaled intermediate data elements, and add a bias term b3 to the sum to generate an intermediate data element a3 (e.g., a3_1, a3_2, a3_m). For example, processing node 312_1 can generate intermediate output data element a3_1 as follows:

$$a3\_ 1 = {\sum }_{i = 1}^{i = k} ( w3\_i \times a2\_i ) + b3\_ 1 \qquad ( Equation 3 )$$

In Equation 3, w3_i represents one of the set of weight elements w3 used by a processing node of neural network layer 312 to scale an intermediate input data element a2_i output by one of the processing nodes of neural network layer 310. For example, processing node 312_1 scales intermediate data element a2_1 from processing node 310_1 with a weight element w3_1, and scales intermediate data element a2_k from processing node 310_k with a weight element w3_k. Also, b3_1 represents the bias term added to the sum of scaled intermediate data elements. A different processing node of neural network layer 312, such as processing node 312_2, 312_m, etc., can scale the intermediate data elements a2 with a different set of weight elements w3 to generate the sum, and add a different bias term b3 to the sum.

Also, neural network layer 314 can be an output layer with n number of processing nodes and mirrors neural network layer 306, which can be the input layer. Each of the n number of processing nodes of the neural network layer 314 can receive an intermediate data element a3 from each processing node of neural network layer 312 (e.g., a3_1 from processing node 312_1, a3_2 from processing node 312_2, a3_m from processing node 312_m), scale the intermediate elements with a set of weights w4, sum the scaled intermediate data elements, and add a bias term b4 to the sum to generate an intermediate data element a4. For example, processing node 314_1 can generate intermediate output data element a4_1 as follows:

$$a4\_ 1 = {\sum }_{i = 1}^{i = m} ( w4\_i \times a3\_i ) + b4\_ 1 \qquad ( Equation 4 )$$

In Equation 4, w4_i represents one of the set of weight elements w4 used by a processing node of neural network layer 314 to scale an intermediate input data element a3_i output by one of the processing nodes of neural network layer 312. For example, processing node 314_1 scales intermediate data element a3_1 from processing node 312_1 with a weight element w4_1, scales intermediate data element a3_2 from processing node 312_2 with a weight element w4_2, and scales intermediate data element a3_m from processing node 312_m with a weight element w4_m. Also, b4_1 represents the bias term added to the sum of scaled intermediate data elements. A different processing node of neural network layer 314, such as processing node 314_2, 314_n, etc., can scale the intermediate data elements a3 with a different set of weight elements w4 to generate the sum, and add a different bias term b4 to the sum.

Processing operation 208 can also include an inverse batch normalization operation 322, which is an inverse of batch normalization operation 320, to convert intermediate data elements a4 to output data elements out (e.g., out_0, out_1, . . . out_n), as follows:

$$out = inverse\_batch \_norm ( a 4 ) \qquad ( Equation 5 )$$

The encoder section 302 can be trained, via adjusting the sets of weight elements w1 and w2 and the sets of bias elements b1 and b2, to extract features from the input data that are most relevant in representing a particular inference outcome (e.g., normal operation of a device, occurrence of a normal event, etc.) while removing features that are not as relevant. The extracted features, as represented by intermediate outputs a1 and a2, have a lower dimension (and a few number of elements) than the batch of input data elements. Accordingly, a batch of input data elements a0 has n data elements, which is reduced to a set of m intermediate data elements a1 by neural network layer 308, and the set of m intermediate data elements a1 is further reduced to a set of k intermediate data elements a2.

Further, in a case where the encoder section 302 can extract the more relevant features of the input data elements, the decoder section 304 can be trained, via adjusting the sets of weight elements w3 and w4 and the sets of bias elements to reconstruct the n output data elements out_0, out_1, . . . out_n from the intermediate data elements a2 that match with the input data elements in_0, in_1, . . . in_n. Accordingly, neural network layer 312 reconstructs m intermediate data elements a3 from k intermediate data elements a2, neural network layer 314 reconstructs n intermediate data elements a4 from the m intermediate data elements a3, and inverse batch normalization operation 322 generates the n output data elements out_0 . . . out_n from the n intermediate data elements a4.

Together, the sets of weight elements w1, w2, w3, and w4 and the sets of bias elements b1, b2, b3, and b4 of autoencoder 300 can be trained using a set of input data including features representing a particular inference outcome (e.g., a normal operation of a device, the occurrence of a normal event, etc.). If a subsequent set of input data also includes features representing the particular inference outcome, the difference between the input and output data elements of the trained autoencoder 300 can still be minimized. On the other hand, if a subsequent set of input data includes features representing a different inference outcome (e.g., abnormal/faulty operation of the device, the occurrence an abnormal event, etc.), the difference between the input and output data elements can exceed a threshold, which can indicate that autoencoder 300 predicts a different inference outcome.

Accordingly, processing operation 208 can implement an error loss function 324, such as a mean square error (MSE) loss function, to compute the difference (or error) between the input and output data elements. Processing operation 208 can also perform a comparison operation 326 to compare the error with a threshold based on, for example, mean (u) and standard deviation (o) of the training data. The error exceeds the threshold, processing operation 208 can output a particular inference result indicating, for example, the normal operation of a device, the occurrence of a normal event, etc. If the error does not exceed the threshold, processing operation 208 can output a particular inference result indicating, for example, the normal operation of a device, the occurrence of a normal event, etc.

As described above, the sets of weight elements w1, w2, w3, and w4 and the sets of bias elements b1, b2, b3, and b4 of autoencoder 300 can be trained using a set of input data including features representing a particular inference outcome, where the goal of the training is to minimize the difference between the input and output data elements of autoencoder 300. In one example, autoencoder 300 can be trained using a backpropagation operation, in which the error in the outputs of the output neural network layer (e.g., neural network layer 314), computed using loss function 324 (e.g., a mean square error (MSE) loss function), is determined, and the gradient of the loss/error with respect to the weight and bias elements of that particular neural network layer is computed. The error is also propagated backward to the preceding neural network layer (e.g., neural network layer 312), and the gradient of the propagated loss/error with respect to the weight and bias elements of the preceding neural network layer. The propagation of the error/loss and the computation of the gradient is repeated for other preceding neural network layers. The weight and bias elements of each neural network layer are then updated based on the loss/error gradient for that neural network layer.

For example, in a training operation, training data including a set of input data elements (e.g., in_0, in_1, in_n) are input to autoencoder 300 with a current set of weight elements w1, w2, w3, w4 and a set of bias elements b1, b2, b3, and b4. In some examples, the error at the output layer (e.g., neural network layer 314), or the loss function L, in terms of means square error (MSE), can be computed as follows:

$$L = \frac{1}{n} \sum {( a 4 - a 0 )}^{2} \qquad ( Equation 6 )$$

In Equation 5, n is the number of input data elements in a batch (and the number of processing nodes in the input layer), a4 are the output elements of neural network layer 314 as well as the inputs to inverse batch normalization operation 322), a0 are the output elements of batch normalization operation 320. The loss can define how well the autoencoder encodes a0 and then recovers the most important features of a0 (as a4) using the current sets of weight elements and bias elements, and the training operation is to update the weight elements and bias elements to minimize the loss, so that the autoencoder can recover as much important features of a0 as possible.

The weights and bias of each neural network layer are updated as follows:

$$w\_n = w - [ vtw \cdot m + η \cdot {∇}_{w} L ] \qquad ( Equation 7 )$$

$$b\_n = b - [ vtb \cdot m + η \cdot {∇}_{b} L ] \qquad ( Equation 8 )$$

In Equation 7, w represents the current weight elements of a neural network layer, w_n represents the updated weight elements of the neural network layer. Also, vtw represents a current weight update with momentum, m represents a momentum constant, η represents a learning rate, and ∇_{w}L represents partial derivative of the loss with respect to weight elements of the neural network layer. Also, in Equation 8, b represents the current bias elements of the neural network layer, b_n represents the updated bias elements of the neural network layer. Also, vtb represents a current bias update with momentum, and ∇_{b}L represents partial derivative of the loss with respect to bias elements of the neural network layer. For neural network layer 314, the loss gradient with respect to bias is as follows:

$${L}_{a 4} = \frac{\partial L}{\partial a 4} = - \frac{2}{n} ( at 4 - a 4 ) = - e \qquad ( Equation 9 )$$

And the loss gradient with respect to weights (w4) is as follows:

$$\frac{\partial L}{w 4} = \frac{\partial L}{\partial a 4} \frac{\partial a 4}{\partial w 4} = {L}_{a 4} * a 3 \qquad ( Equation 10 )$$

In Equations 9 and 10, e represents the error at neural network layer 314 between the intermediate data elements a4 and their targets/references. Also, the loss gradient with respect to weights is a function of the input to neural network layer 314 (intermediate data elements a3 from neural network layer 312).

And the weight elements w4 and bias elements b4 are updated as follows:

$$w4\_n = w 4 - [ vtw * m + η * a 3 * e ] \qquad ( Equation 11 )$$

$$b4\_n = b 4 - [ vtb * m + η * e ] \qquad ( Equation 12 )$$

In Equation 11, a3*e represent loss gradients of weight elements computed from products of input data to the neural network layer (e.g., a3 for neural network layer 314) and instantaneous errors at the neural network layer (e). In Equation 12, e (errors) also represent loss gradients of bias elements (partial derivatives).

The training operation can be repeated based on Equations 5-12 above for preceding neural network layers, such as neural network layers 312, 310, 308, and 306 by propagating the error backwards. For example, for neural network layer 312, the target outputs a4t at neural network layer 314 can be used to compute the target inputs to neural network layer 312 (a3t) based on the current set of weight and bias elements of neural network layer 312 (w3 and b3), which are also the target outputs of neural network layer 312. The error e at neural network layer 312 can then computed based on a difference between the target outputs of neural network layer 312 (a3t) and the actual outputs of neural network layer 312 (a3). The new weight and bias elements of neural network layer 312 (w3_n and b3_n) can be computed based on Equations 11 and 12, with a3 replaced by a2 in Equation 11.

In some examples, machine learning model 210 can include a deep neural network (DNN) having multiple neural network layers, including an input layer, an output layer, and one or more hidden layers between the input layer and the output layer. Each neural network layer includes processing nodes, and each processing node can scale input data with a set of weights, sum the scaled input data, and add a bias term to the sum to mimic the operation of a neuron, based on the Equations 1-4 above. However, in contrast to autoencoder 300, the hidden layers do not have form a bottleneck section with a reduced size/dimension compared with the input and output layers. Also, DNN can be configured as a classification network to classify the inputs into one of multiple categories. The outputs of the DNN can represent, for example, probabilities of the inputs belonging to each one of the multiple classification categories, and processing operation 208 can output the category having the highest probability. For example, the DNN can output a first probability of the inputs being classified as representing normal operation of a device and a second probability of the inputs being classified as representing abnormal/faulty operation of the device. If the first probability is higher than the second probability, processing operation 208 can output an indication that normal operation of the device is detected. But if the second probability is higher than the first probability, processing operation 208 can output an indication that abnormal/faulty operation of the device is detected.

The DNN can also be trained using the aforementioned backward propagation operation, but with a loss function defined based on cross entropy instead of mean square error. The training data for the DNN can also include input data representing different classification categories, as well target category labels for the input data. The goal of the training is to minimize the cross entropy loss function, which represents the mismatch between the categories output by the DNN and the target categories (e.g., represented by a4t). The update of the weight and bias elements for a neural network layer of DNN, based on cross entropy loss gradient, can also be based on Equations 11 and 12 above.

Referring again to FIG. 1, in some examples, data processor 106 of each electronic device 102 can receive data 120 (e.g., 120a, 120b, and 120c) including, for example, compiled instructions representing each layer of a neural network model, as well as the model parameters of the neural network model, such as a set of weight elements and a set of bias elements from cloud network 103. In some examples, cloud network 103 can perform the aforementioned backward propagation training operation of the neural network model to generate or update the model parameters. As part of the training operation, cloud network 103 can receive outputs 110 (e.g., outputs 110a, 110b, and 110c) generated by electronic devices 102, as well as sensor signals generated by sensors 104 of electronic devices 102 responsive to the stimulus sensed by sensors 104, such as stimuli 108a, 108b, and 108c. Cloud network 103 can also receive the target/reference outputs for these stimuli, and adjust the model parameters to reduce/minimize the errors in the outputs of the neural network model (relative to the reference/target outputs) in processing the sensor signals representing the stimuli. After completing the training operation, cloud network 103 can transmit the new model parameters back to electronic devices 102. Electronic devices 102 can then perform inferencing operations using the neural network model with the new model parameters.

As described above, the training operation performed by cloud network 103 is based on stimuli received by electronic devices 102, their outputs responsive to the stimuli, as well as the target/reference outputs of the electronic devices 102 for those stimuli. Such arrangements can take into account the local operating condition of each individual electronic device 102, which can improve the robustness of the training operation. But the robustness can be limited when some of the electronic devices have vastly different operating conditions. Given that all electronic devices 102 share the same machine learning model and same model parameters, those model parameters may be optimal (e.g., achieving lowest loss) for some of the electronic devices but not for all of the electronic devices.

Performing training operation at cloud network 103 may also impose limit on the scalability and frequency of the training operation. Specifically, as more electronic devices 102 are added to the system, existing electronic devices 102 are reconfigured (e.g., being mounted on a new motor, sensors being replaced), etc., the machine learning model may be retrained to account for a set of new operating conditions for the additional electronic devices 102, but the complexity of the training operation increases as more input data and output data for the additional electronic devices are input to the training operation, which can increase the duration of the training operation, as well as the computation and memory resources used for the training operation. Because of the increased duration and resource usage of the training operation, the machine learning model also cannot be trained frequently, which may make it difficult to adapt the machine learning model to changes in the operation conditions of electronic devices 102.

One way to address such issues is by performing on-chip training, where the training operation of the machine learning model occurs locally at electronic device 102. Referring again to FIG. 1, each of electronic devices 102a, 102b, and 102c can receive compiled instructions representing each layer of a neural network model, as well as the initial model parameters of the neural network model. And then each of electronic devices 102a, 102b, and 102c (e.g., processor 106) can perform training operation locally using the stimulus received by each electronic device to update the model parameters. For example, processor 106a of electronic device 102a can perform a local training operation using stimulus 108a sensed by sensor 104a, processor 106b of electronic device 102b can perform a local training operation using stimulus 108b sensed by sensor 104b, and electronic device 102c can perform a local training operation using stimulus 108c sensed by sensor 104c. Accordingly, while electronic devices 102 share the same machine learning model, the machine learning model parameters may be different among the devices.

The on-chip training operation can provide various advantageous. Specifically, because the training operation occurs locally at each electronic device 102, the training operation can become distributive and naturally scalable with the number of electronic devices 102, and the complexity of the training operation does not increase with the number of electronic devices 102. This also allows the training to be performed more frequently (e.g., when an electronic device 102 is reconfigured, responsive to loss exceeding a threshold, etc.), to adapt the machine learning model to changes in the operating conditions of electronic devices 102. Also, because each electronic device 102 can perform a local training operation that accounts for the local operating condition, the model parameters generated from the local training operation can be optimal for each electronic device. Further, because each electronic device 102 needs not transmit input and output data of the machine learning model to cloud network 103 to support the training operation, transmission of data between cloud network 103 and electronic devices 102 can be reduced, which not only reduces power but also privacy/security risks associated with the data transmission.

In some examples, one on-chip training round can involve a single batch of input data, where the model parameters (e.g., weight and bias elements) are updated based on that single batch of input data. Such arrangements can reduce the memory usage of the training operation, which can facilitate the implementation of on-chip training on devices with limited memory resources.

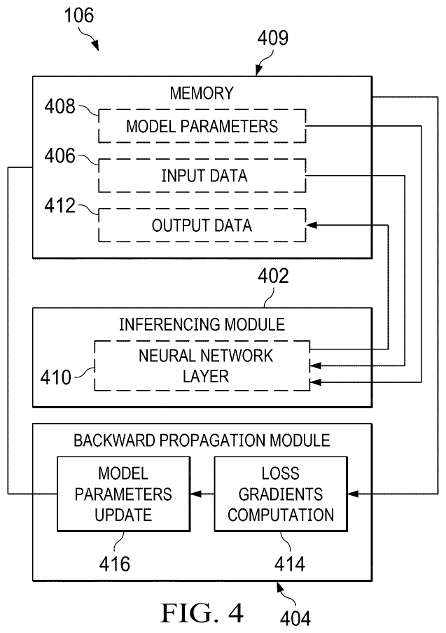

FIG. 4 illustrates examples of internal components of processor 106 to support an on-chip training operation. Referring to FIG. 4, processor 106 can include an inferencing module 402 and a backward propagation module 404. Each module can include circuitry and/or software instructions. For example, as to be described below, processor 106 can include an execution unit to execute compiled instructions for each module. Processor 106 can also include arithmetic circuitry (e.g., matrix multiplication accelerator (MMA)) to perform computations described in some of the aforementioned Equations.

Referring to FIG. 4, inferencing module 402 can fetch input data 406 and a set of current model parameters 408 (e.g., weight and bias elements). The input data and the model parameters can be fetched from a memory 409, which can be internal or external to processor 106. In FIG. 4, input data 406 can represent a batch of input data from pre-processing operation 206 (e.g., frequency components in 120 frequency bins), or intermediate data generated by the preceding neural network layers from the batch of input data. Inferencing module 402 can provide the data and parameters to a neural network layer 410, to generate output data 412 for the neural network layer 410. For example, in a case where neural network layer 410 is neural network layer 314 of FIG. 3, inferencing module 402 can fetch weight and bias elements w4 and b4 as part of model parameters 408, and compute intermediate data a4 as output data 412 based on Equation 4 above. In some examples, the computation can be performed using an MMA.

Backward propagation module 404 may include a loss gradients computation module 414 and a model parameters update module 416. Referring back to Equation 6 above, loss gradients computation module 414 can compute the target output data for neural network layer 410 from output data 412, compute the error (e) between the target output data and output data 412 for neural network layer 410, compute the loss gradients for weight and bias elements (e.g., w4 and b4) based on the error e according to Equations 9 and 10. Model parameters update module 416 can compute a new set of model parameters (e.g., w4_n and b4_n) based on the loss gradients according to Equations 11 and 12, and update model parameters 408 in memory 409 with the new set of model parameters. Processor 106 can also propagate the error back to the prior neural network layers (e.g., neural network layers 312, 310, 308, and 306) and compute the error at each of the prior neural network layers and adjust the weight and bias elements of each neural network layer based on the error.

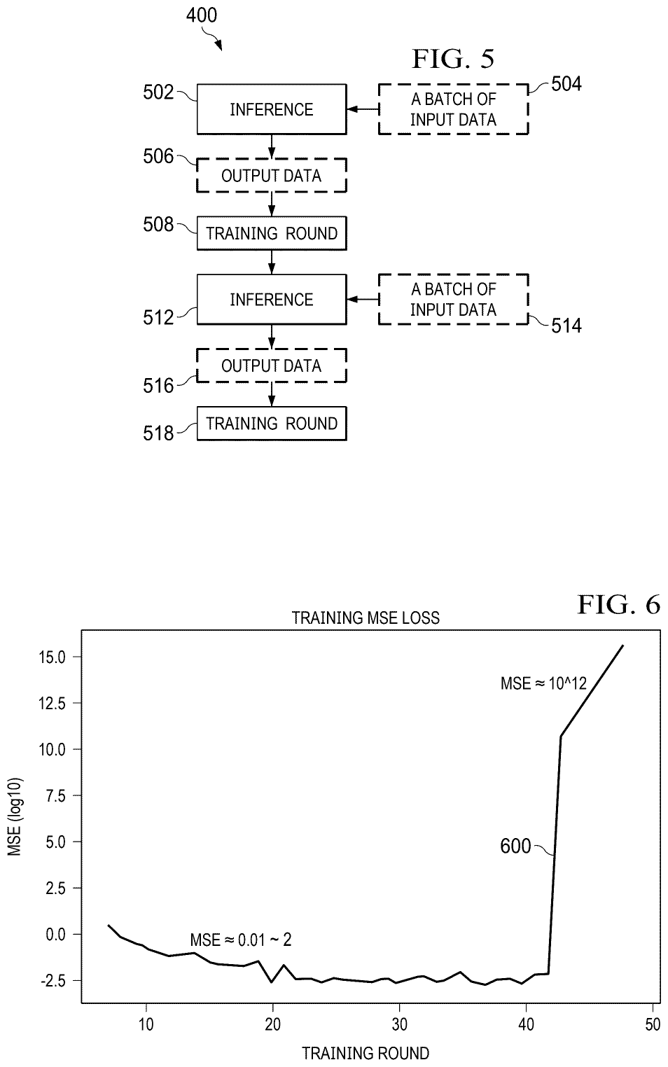

FIG. 5 illustrates an example of an on-chip training operation of an autoencoder (e.g., autoencoder 300) based on single batches of input data that can be implemented by inferencing module 402 and backward propagation module 404 of processor 106. Referring to FIG. 5, inferencing module 402 can perform an inference operation 502 using a first batch of input data 406 (e.g., a first set of frequency components in 120 frequency bins) to generate a first set of output data 506 (e.g., out_0, out_1, . . . out_n in FIG. 3). Backward propagation module 404 can then perform a first round of training operation 508 using the first set of output data 406. For example, referring back to Equation 6 above, backward propagation module 404 can compute the target output data for neural network layer 314 from output data 406, compute the errors (e) between the target output data and output data 406 for neural network layer 314, compute the loss gradients for weight and bias elements (w4 and b4) based on the errors e according to Equations 9 and 10, and then adjust the weight elements w4 and bias elements b4 of neural network layer 314 based on the loss gradients according to Equations 11 and 12. Backward propagation module 404 can also propagate the errors back to the prior neural network layers (e.g., neural network layers 312, 310, 308, and 306) and compute the errors at each of the prior neural network layers and adjust the weight and bias elements of each neural network layer based on the errors.

After the round of training operation 508 completes and the model parameters are updated, inferencing module 402 can perform another inference operation 512 using a second batch of input data 514 (e.g., a second set of frequency components in 120 frequency bins) to generate a second set of output data 516 (e.g., out_0, out_1, . . . out_n in FIG. 3). Backward propagation module 404 can then perform a second round of training operation 518 using the second set of output data 516 and update the weight and bias elements of the machine learning model. Accordingly, the weight and bias elements of the machine learning model are updated per batch of input data.

The arrangements of FIG. 5 can reduce the memory usage of the on-chip training operation. Specifically, for each training round, memory resource is provided to store a single batch of input data, as well as the intermediate data and output data of the neural network layers (from the inferencing operation) and the target intermediate data and output data of the neural network layers (for error computation) generated from that single batch of input data. After a training round completes, the memory can be overwritten with a new single batch of input data as well as a new set of intermediate data, output data, and their targets generated from the new single batch of input data. Such arrangements can reduce the overall memory footprint of the data involved in a training round, which can facilitate the implementation of on-chip training on devices with limited memory resources.

Although the on-chip training operation of FIG. 5, which updates the model parameters per batch of input data, can reduce memory usage, the robustness of the on-chip training operation can be degraded when the input signals exhibit rapid and large variations (e.g., transients) with time. The error (and loss) also include the transients. Such rapid and large transients in the input signals (and error) may not provide features useful for detection/non-detection of an event, and may be present in some batches of input data and may be absent in other batches of input data. If the batch of input data provided to a prior round of training operation does not include such transients, and a new batch of input data provided to a new round of training operation includes such transients, the new round of training round may compute a large (and false) error, as well as a large (and false) loss gradient, from the new batch of input data. This can lead to gradient explode.

FIG. 6 includes a graph 600 that illustrates an example of gradient explode caused by an on-chip training operation where the loss gradient is computed based on a single batch of input data. As shown in FIG. 6, in each training round from round #10 to round #40, the mean square error (MSE) computed in each training round is within a narrow range of 0.01 to 2. But after round #40, due to the presence of the transients in the input signals, the MSE jumps to 1012. The substantial error (and loss gradient) is due to those transients being absent in the input signals for training rounds #10 to #40. If those transients do not provide useful features for detection of an event (e.g., faulty operation of a device, an abnormal event, etc.), the training operation may adjust the weight and bias elements based on the false loss gradient, which degrades the robustness of the on-chip training operation.

Moreover, stability issue may arise where the training operation combines a large learning rate (η in Equations 11 and 12) with the large loss gradient. This is because in one training round with a batch of input data with the transients, the training operation may adjust the model parameters by a large amount in one direction based on a large loss gradient. And then in a subsequent training around with another batch of input data without the transients (or with transients in an opposite direction), the training operation may again compute another large loss gradient, and adjust the model parameters again by a large amount but in an opposite direction. As the large loss gradient persists (but in opposite directions), the training operation may continue to adjust the model parameters by a large amount in opposite directions across subsequent rounds, which can lead to the model parameters being unstable.

The gradient explode problem can be alleviated in various ways but each has its own drawback. For example, to improve stability, the training operation can be configured to use a reduced learning rate. But such arrangements can lead to slow training convergence. As another example, instead of adjusting the model parameters from a training operation using a single batch of input data, the model parameters can be adjusted by a training operation that uses multiple batches of input data. For example, multiple loss gradients can be computed from multiple batches of input data with the same current set of model parameters. The loss gradients can be averaged to attenuate the huge loss gradient caused by the transients, and the current set of model parameters can then be adjusted using the averaged gradient. Such arrangements, however, may require substantial memory resource to store the multiple batches of input data, as well as the intermediate and output data generated from the multiple batches of input data to perform the averaging, and may be unsuitable for devices with limited memory resources.

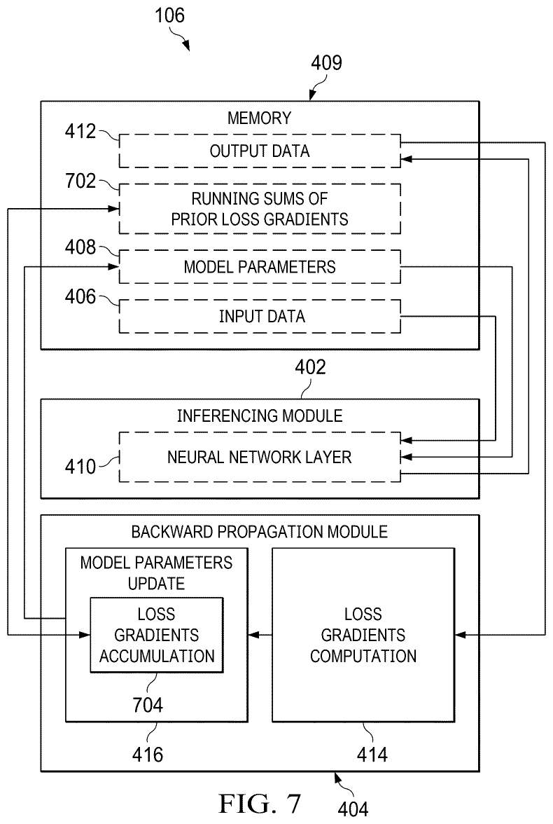

FIG. 7 illustrates examples of components of processor 106 that can address at least some of the issues described above. Referring to FIG. 7, model parameters update module 416 can include a loss gradients accumulation module 704, which can maintain a running sum of prior loss gradients 702 in memory 409. During a training operation, loss gradients computation module 414 can compute the instantaneous/latest loss gradients based on the instantaneous errors e (e.g., a3*e for weight elements w4 and e for bias elements b4 for neural network layer 314). Loss gradients accumulation module 704 can add the latest loss gradients to the running sum of prior loss gradients 702 computed over multiple prior training rounds.

The running sum can be updated in each training round with loss gradients computed from a batch of input data. For example, for neural network layer 314, the loss gradients can be a3·e for weight elements w4 and e for bias elements b4, where e are the errors between the actual outputs a4 and target outputs a4t of neural network layer 314. The running sum of prior loss gradients 702 can include a running sum of a3·e for weights w4 and a running sum of e for bias b4 of neural network layer 314, and running sums for other loss gradients for other neural network layers, across different training rounds. The running sum can smooth out (e.g., lowpass filter) the large transients in the input data as well as the large transients in the loss gradients with time, which can prevent or least reduce the aforementioned gradient explode issue. On the other hand, the running sum can reflect longer term (e.g., static) errors, and backward propagation module 704 can adjust the weight/bias elements to reduce the running sum to zero, so that the longer term errors can also be close to zero. Those longer term errors can indicate a persistent feature/pattern, rather than a transient feature, in the input data that the machine learning model does not properly account for in the inferencing operation. Accordingly, adjusting the weight/bias elements to eliminate the longer term errors can improve the robustness of the machine learning model in the inferencing operation.

In some examples, loss gradients computation module 414 can also compute an average error e over a sliding window of training rounds including the latest training round, determine the loss gradient based on the average error ē (e.g., a3*ē for weight elements w4 and ē for bias elements b4 for neural network layer 314), and loss gradients accumulation module 704 can add the latest loss gradients to the running sum of prior loss gradients 702 computed over multiple prior sliding windows. Such arrangements can further attenuate the huge loss gradient caused by the transients and alleviate the gradient explode problem.

In some examples, loss gradients accumulation module 704 can also clamp the running sum (e.g., by resetting it to zero, by dividing the running sum with a number to obtain an average, etc.). In some examples, loss gradients accumulation module 704 can clamp the running sum responsive to the running sum exceeding a threshold value to prevent overflow.

Model parameters update module 416 can generate update parameters based on the updated running sums, and adjust the model parameters (e.g., weight elements and bias elements) based on the update parameters. For example, for neural network layer 314 of FIG. 3, loss gradients accumulation module 704 can generate update parameters based on the running sums, and model parameters update module 416 can update weight elements w4 and bias elements b4, as follows:

$$w4\_n = w 4 - [ \int a 3 \cdot edt ] \qquad ( Equation 13 )$$

$$b4\_n = b 4 - [ \int edt ] \qquad ( Equation 14 )$$

In Equation 13, § a3·e dt is an integral of a3·e, which represents running sums of loss gradients a3·e for weight elements w4. The update parameters for weight elements w4 are generated based on the running sums of loss gradients a3·e. Also, in Equation 14, § e dt represents a running sum of loss gradients e for bias elements b4. The update parameters for bias elements b4 are generated based on the running sums of loss gradients e.

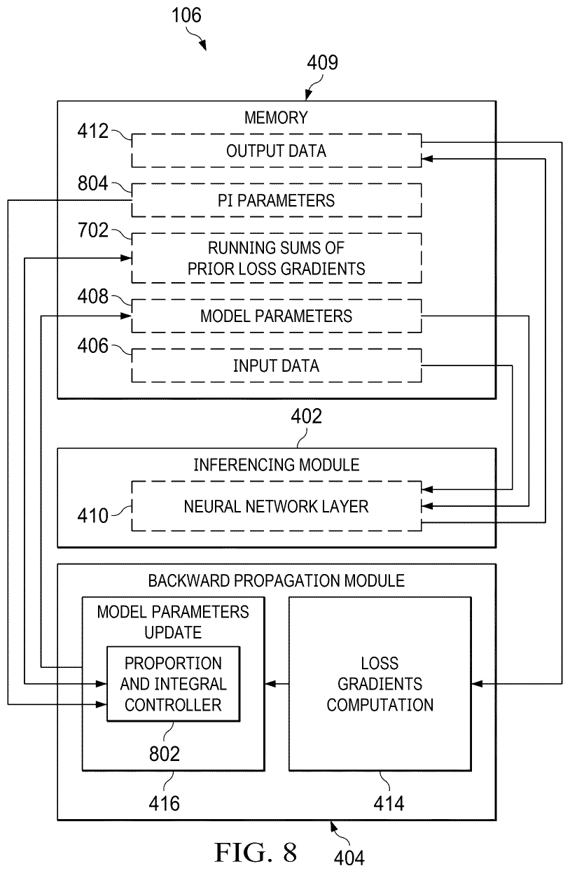

FIG. 8 illustrates additional examples of components of processor 106. Referring to FIG. 8, model parameters update module 416 can include a proportional and integral (PI) controller 802. Proportional and integral (PI) controller 802 can generate proportional adjustment parameters and integral adjustment parameters based on the latest loss gradients computed by loss gradients computation module 414. Specifically, the proportional adjustment parameters can be based on the latest loss gradients, which allows backward propagation module 704 to respond quickly to the transient by adjusting the weight/bias elements and reduce the error caused by the transient, which can improve system stability and reduce the likelihood of system oscillation (e.g., weights and bias oscillating around certain values between training rounds). Also, the integral adjustment parameters are based on the running sum of prior loss gradients 702, which can smooth out the large transients in the loss gradients with time and prevent or least reduce the aforementioned gradient explode issue.

For example, for neural network layer 314 of FIG. 3, proportional and integral controller 802 can generate proportional update parameters based on the latest loss gradients and integral update parameters based on the updated running sums of prior loss gradients 702, and model parameters update module 416 can update weight elements w4 and bias elements b4, as follows:

$$w4\_n = w 4 - [ {K}_{pw} * a 3 * e + {K}_{iw} \int a 3 * edt ] \qquad ( Equation 15 )$$

$$b4\_n = b 4 - [ {K}_{pb} * e + {K}_{ib} \int edt ] \qquad ( Equation 16 )$$

In Equation 15, K_{pw}·a3·e represent the proportional adjustment parameters for weight elements w4, and K_{iw} § a3·e dt represent the integral adjustment parameters for weight elements w4. Also, in Equation 16, K_{pb}·e represent the proportional adjustment parameters for bias elements b4, and K_{ib} § e dt represent the integral adjustment parameters for weight elements b4. K_{pw}, K_{iw}, K_{pb}, and K_{ib} can be part of PI parameters 804 in memory 409 and can be part of hyper parameters of the machine learning model. In some examples, the instantaneous error e in Equations 15 and 16 can be presented by the average error ē as explained above.

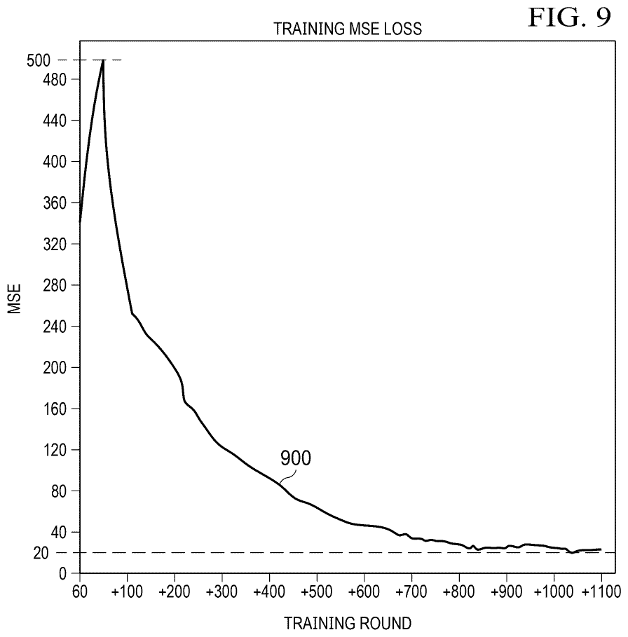

FIG. 9 includes a graph 900 that illustrates an example of variations of MSE with respect to training round by an on-chip training operation performed by backward propagation module 404 of FIGS. 7 and 8 based on a running sum of prior loss gradients. As shown in FIG. 9, the MSE starts at a relatively high value (e.g., 500) at the first training round, but as the training progresses the MSE converge to a low value (e.g., 20) with a flat slope, and the gradient explode issue shown in FIG. 6 can be avoided.

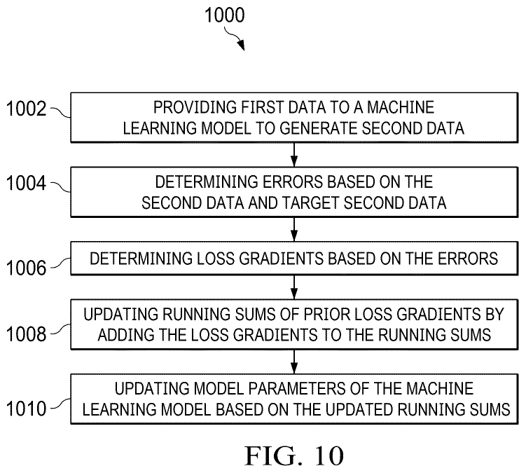

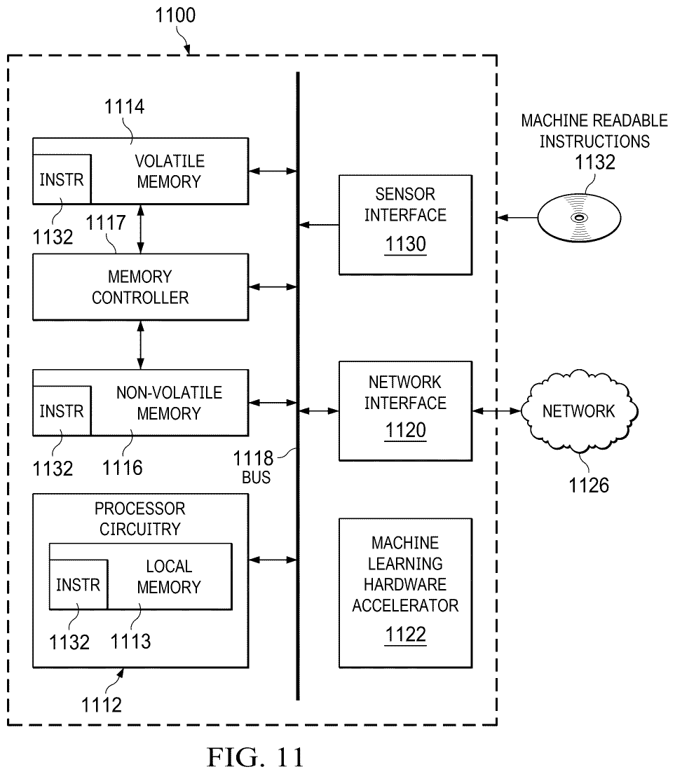

FIG. 10 illustrates a flowchart of a method 1000 of training a neural network. Method 1000 can be performed by, for example, inferencing module 402 and backward propagation module 404 of examples described herein. Referring to FIG. 10, in operation 1002, inferencing module 402 can provide first data to a machine learning model (e.g., neural network layer 410) to generate second data. The machine learning model can include, for example, an autoencoder, a DNN, etc. In some examples, the first data can be a single batch of input data, or intermediate data generated by preceding neural network layers from that single batch of input data, where a single batch represents a number of input data elements that the machine learning model can process at a time. The single batch can be based on, for example, a number of processing nodes of the input layer of the machine learning model. In some examples, the input data comes from a Fourier transform pre-processing operation (e.g., an FFT operation), the single batch can be based on a number of frequency bins output by the FFT operation.

In operation 1004, backward propagation module 404 can determine errors based on the second data and target second data. The determination of the errors can be based on a loss function. For an autoencoder, the target second data can be computed from the second data, such as based on Equation 6. For DNN, the target second data can be provided externally as reference data (e.g., an expected classification output). For an autoencoder, the loss function can be based on mean square error (MSE) between the second data and the target second data. For a DNN (or a classification network), the loss function can be based on cross entropy.

In operation 1006, backward propagation module 404 can determine loss gradients based on the errors. Backward propagation module 404 can determine the loss gradients with respect to weight elements and the loss gradients with respect to bias elements based on Equations 9 and 10.

In operation 1008, backward propagation module 404 can update running sums of prior loss gradients by adding the loss gradients, determined in operation 1006, to the running sums, according to Equations 13 and 14. The running sums can be an integration operation to smooth out/low pass the transients in the loss gradients, and can be updated per training round and per batch of input data. In some examples, backward propagation module 404 can clamp the running sums (e.g., resetting to zero, dividing the running sums with a number to obtain an average, etc.) if the running sums exceed a threshold, to prevent overflow.

In operation 1010, backward propagation module 404 can update the model parameters of the machine learning model based on the updated running sums. In some examples, backward propagation module 404 can include a PI controller, such as PI controller 802, to generate a proportional adjustment parameters and integral adjustment parameters, and adjust the weight elements and bias elements based on the proportional adjustment parameters and integral adjustment parameters according to Equations 15 and 16.

FIG. 8 is a block diagram of an example processor platform 1100 including processor circuitry structured to execute machine-readable instructions. Processor platform 1100 can be part of, or can include, processor 106. Processor platform 1100 of the illustrated example can include processor circuitry 1112. The processor circuitry 1112 of the illustrated example includes hardware. For example, processor circuitry 1112 can be implemented by one or more integrated circuits, logic circuits, FPGAs, microprocessors, Central Processing Units (CPUs), Graphical Processing Units (GPUs), Digital Signal Processors (DSPs), and/or microcontrollers from any desired family or manufacturer. Processor circuitry 1112 can be implemented by one or more semiconductor-based (e.g., silicon-based) devices. Processor circuitry 1112 can execute compiled instructions, such as instructions representing neural network layers and their computations. In some examples, processor platform 1100 can also include a machine learning hardware accelerator 1122, which can include a matrix multiplication accelerator (MMA) and other circuitry to facilitate neural network computations. Machine learning hardware accelerator 1122 can be external to or can be part of processor circuitry 1112. Processor circuitry 1112 and machine learning hardware accelerator 1122 together can implement, for example, inferencing module 402 and backward propagation module 404.

Processor circuitry 1112 of the illustrated example can include a local memory 1113 (e.g., a cache, registers, etc.). Local memory 1113 can be an example of memory 409 and can store, for example, model parameters 408, input data and output data for each neural network layer, and running sums of prior loss gradients 702. Processor circuitry 1112 of the illustrated example is in communication with a computer-readable storage device such as a main memory including a volatile memory 1114 and a non-volatile memory 1116 by a bus 1118. The volatile memory 1114 can be implemented by, for example, Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by programmable read-only memory, flash memory and/or any other desired type of non-volatile memory device. Access to the main memory 1114, 1116 of the illustrated example can be controlled by a memory controller 1117.

The processor platform 1100 of the illustrated example also includes network interface circuitry 1120 for connection to a network 1126 (e.g., cloud network 103). The network interface circuitry 1120 may be implemented by hardware in accordance with any type of interface standard, such as an Inter-Integrated Circuit (I2C) interface, a Serial Peripheral Interface (SPI), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

The processor platform 1100 of the illustrated example also includes a sensor interface 1130, via which the processor platform 1100 can receive sensor signals (e.g., voltage and current measurement signals, acoustic signals, vibration signals, etc.) from, for example, sensor 104. The processor platform 1100 also includes analog-to-digital converters (not shown in the figure) to convert analog signals to digital signals for processing by the processor circuitry 1112.

Machine-readable instructions 1132 can be stored in volatile memory 1114 and/or non-volatile memory 1116. Upon execution by the processor circuitry 812, the machine-readable instructions 1132 cause the processor platform 1100 to perform any or all of the functionality described herein attributed to processor 106, such as method 1000. The instructions can represent machine learning models, as well as applications that invoke the machine learning models to perform an inferencing operation on sensor signals received via sensor interface 1130.

In this description, the term “couple” may cover connections, communications, or signal paths that enable a functional relationship consistent with this description. For example, if device A provides a signal to control device B to perform an action, then: (a) in a first example, device A is coupled to device B; or (b) in a second example, device A is coupled to device B through intervening component C if intervening component C does not substantially alter the functional relationship between device A and device B, such that device B is controlled by device A via the control signal provided by device A. Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, in this description, a circuit or device that includes certain components may instead be adapted to be coupled to those components to form the described circuitry or device. For example, a structure described as including one or more semiconductor elements (such as transistors), one or more passive elements (such as resistors, capacitors and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end-user and/or a third party.

While particular transistor structures are referred to above, other transistors or device structures may be used instead. For example, p-type MOSFETs may be used in place of n-type MOSFETs with little or no additional changes. In addition, other types of transistors (such as bipolar transistors) may be utilized in place of the transistors shown. The capacitors may be implemented using different device structures (such as metal structures formed over each other to form a parallel plate capacitor) or may be formed on layers (metal or doped semiconductors) closer to or farther from the semiconductor substrate surface.

As used above, the terms “terminal”, “node”, “interconnection” and “pin” are used interchangeably. Unless specifically stated to the contrary, these terms are generally used to mean an interconnection between or a terminus of a device element, a circuit element, an integrated circuit, a device or other electronics or semiconductor component.

While certain components may be described herein as being of a particular process technology, these components may be exchanged for components of other process technologies. Circuits described herein are reconfigurable to include the replaced components to provide functionality at least partially similar to functionality available before the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in series or in parallel between the same two nodes as the single resistor or capacitor. Also, uses of the phrase “ground terminal” in this description include a chassis ground, an Earth ground, a floating ground, a virtual ground, a digital ground, a common ground, and/or any other form of ground connection applicable to, or suitable for, the teachings of this description. Unless otherwise stated, “about”, “approximately”, or “substantially” preceding a value means +/−10 percent of the stated value.

Modifications are possible in the described examples, and other examples are possible, within the scope of the claims.

What is claimed is:

1. A method comprising:
providing first data to a machine learning model to generate second data;
determining errors based on the second data and target second data;
determining loss gradients based on the errors;
updating running sums of prior loss gradients by adding the loss gradients to the running sums; and
updating model parameters of the machine learning model based on the updated running sums.

2. The method of claim 1, wherein updating model parameters of the machine learning model based on the running sums includes updating model parameters of the machine learning model based on a combination of the loss gradients and the updated running sums.

3. The method of claim 2, further comprising determining the combination using a proportional integral controller.

4. The method of claim 3, wherein determining the combination includes, using the proportional integral controller:
multiplying the loss gradients with a proportional gain parameter to generate proportional adjustment parameters;
multiplying the updated running sums with an integral gain parameter to generate integral adjustment parameters; and
generating the combination based on the proportional adjustment parameters and the integral adjustment parameters.

5. The method of claim 1, further comprising clamping the running sums.

6. The method of claim 1, wherein the machine learning model includes a neural network model.

7. The method of claim 6, wherein the model parameters include weight elements, and the loss gradients are determined based on the first data and the errors.

8. The method of claim 6, wherein the model parameters include bias parameters, and the loss gradients are determined based on the errors.

9. The method of claim 6, wherein the neural network model includes at least one of: a convolutional neural network, a deep neural network, or an autoencoder.

10. The method of claim 1, wherein the machine learning model processes a batch of input data at a time, and the first data includes a single batch of the input data.

11. The method of claim 1, further comprising updating the machine learning model per batch of input data.

12. The method of claim 1, wherein the first data is provided by a sensor, the method is performed by a device including the sensor, and the prior loss gradients are generated from prior first data from the sensor.

13. The method of claim 1, further comprising performing a fault detection operation based on the second data.

14. An integrated circuit comprising:
a sensor interface;
a memory configured to store data and instructions; and
a processor configured to execute the instructions to:
receive first data via the sensor interface;
receive, from the memory, at least a subset of the data representing a machine learning model, model parameters of the machine learning model, and
running sums of prior loss gradients;
generate second data by providing the first data to the machine learning model;
determine errors based on the second data and target second data;
determine loss gradients based on the errors;
update the running sums based on adding the loss gradients to the running sums;
update the model parameters based on the updated running sums; and
store the updated model parameters and the updated running sums in the memory.

15. The integrated circuit of claim 14, wherein the machine learning model is configured to process a batch of input data at a time, and the first data includes a single batch of the input data.

16. The integrated circuit of claim 14, wherein the processor is configured to execute the instructions to update the model parameters of the machine learning model based on a combination of the loss gradients and the updated running sums.

17. The integrated circuit of claim 16, wherein the processor is configured to execute the instructions to implement a proportional integral controller and determine the combination using the proportional integral controller.

18. The integrated circuit of claim 17, wherein the processor is configured to execute the instructions to, using the proportional integral controller:
multiply the loss gradients with a proportional gain parameter to generate proportional adjustment parameters;
multiply the updated running sums with an integral gain parameter to generate integral adjustment parameters; and
generate the combination based on the proportional adjustment parameters and the integral adjustment parameters.

19. The integrated circuit of claim 14, wherein the processor includes a machine learning hardware accelerator.

20. The integrated circuit of claim 14, wherein the machine learning model includes at least one of: a convolutional neural network, a deep neural network, or an autoencoder.

21. The integrated circuit of claim 14, wherein the processor is configured to execute the instructions to provide a fault detection indication based on the second data.
